(19) United States
(12) Patent Application Publication
(10) Pub. No.: US 2022/0042839 A1
(43) Pub. Date: Feb. 10, 2022

(54) SUBSIDENCE SENSING DEVICE WITH LIQUID REPLENISHING MECHANISM

(71) Applicants: Ming-Chun LAI, Hualien (TW); Cheng-Yin SHIH, New Taipei City (TW)

(72) Inventors: Ming-Chun LAI, Hualien (TW); Cheng-Yin SHIH, New Taipei City (TW)

(21) Appl. No.: 16/987,715

(22) Filed: Aug. 7, 2020

(51) Int. Cl. G01F 23/292; F17C 13/02

(52) U.S. Cl. CPC G01F 23/2924; F17C 13/026; F17C 13/021

(57) ABSTRACT

A subsidence sensing device with a liquid replenishing mechanism has multiple liquid storage tanks connected with each other via communicating tubes, multiple level sensors, a liquid feeding tank disposed higher than liquid surfaces of liquids in the liquid storage tanks, and an air inlet tube and a liquid feeding tube communicate the liquid in the liquid storage tanks and feeding liquid in the liquid feeding tank. When the liquids in the liquid storage tanks evaporate gradually due to surrounding temperature or humidity, the feeding liquid in the liquid feeding tank flows into the liquid storage tank and replenish all of the liquid storage tanks via the communicating tubes. Thus, the liquid surfaces of the liquids in the liquid storage tanks can be kept at a predetermined proper liquid level, so as to allow the level sensor to provide accurate signals to monitoring staffs.

### BACKGROUND OF THE INVENTION

### 1. Field of the Invention

The present invention relates to a subsidence sensing device, especially to a subsidence sensing device that has a liquid replenishing mechanism for keeping the subsidence sensing device working normally.

### 2. Description of the Prior Art(s)

Public infrastructures, such as bridges, roads, railways, tunnels, reservoirs, harbors and the like, are closely related to people's lives. Those public infrastructures not only facilitates people's lives, but also improves the quality of life of human beings. However, in areas with frequent natural disasters such as earthquakes and typhoons, if conservation of water and soil was not prioritized, aquatic and geographic environment would be instable. Therefore, the long-term monitoring of the structural safety of the public infrastructures has become one of the research and development priorities of modern civil engineering.

One of the safety monitoring projects of the public infrastructures is to monitor height variance of a location or surrounding environment of the public infrastructure. Take a bridge or a viaduct for example, when places at which some bridge piers are located subside or elevate, a bridge deck may fracture or collapse. Take a railway for example, when slope collapse or landslide occur in an area through which train cabins pass, tracks may displace laterally or deform. Consequently, safety of the passengers of the train would be seriously affected.

With reference to FIG. 9, a conventional subsidence sensing device for monitoring height variance of the location or the surrounding environment of a public infrastructure, as a hydrostatic leveling sensor disclosed in U.S. Pat. No. 9,183,739 and entitled “BRIDGE SAFETY MONITORING INTEGRATED SYSTEM WITH FULL OPTICAL FIBER AND THE METHOD FOR SENSING THEREOF”. The hydrostatic leveling sensor comprises multiple liquid storage tanks 61. Each of the liquid storage tanks 61 contains liquid 610, and the liquid storage tanks 61 are connected with each other via communicating tubes 62. According to Communicating Vessel's principle of Hydrostatics, the liquids 610 in all of the liquid storage tanks 61 balance out to the same liquid level.

Moreover, each of the liquid storage tanks 61 has a fiber-optic sensor 70 mounted therein. The fiber-optic sensor 70 substantially includes a hanged object 71 and a fiber-optic cable 72. An average density of the hanged object 71 is greater than a density of the liquid 610 in the liquid storage tank 61. The hanged object 71 is disposed at a liquid surface of the liquid 610 in the liquid storage tank 61 and is supported by buoyancy force from the liquid 610. The fiber-optic cable 72 is mounted through and is connected with the hanged object 71. A fiber core of the fiber-optic cable 72 is inscribed with fiber Bragg grating. The fiber-optic cable 72 that protrudes out from a top of the hanged object 71 further protrudes out from a top of the liquid storage tank 61, is further securely connected to the liquid storage tank 61 and is wirelessly connected to an optical sensing interrogator. The hanged object 71 that is supported by the buoyant force of the liquid 610 applies a downward tensile force on the fiber-optic cable 72 to keep the fiber Bragg grating at a preset state. When a light signal passes through the fiber-optic cable 72, a reflected signal is generated.

When a place at which one of the liquid storage tanks 61 is located subsides, said liquid storage tank 61 is lowered down as well. Since the liquid storage tanks 61 are connected with each other via the communicating tubes 62, the liquids 610 in the other liquid storage tanks 61 flow toward the lowered liquid storage tank 61 until the liquid surfaces of the liquids 610 in all of the liquid storage tanks 61 reach the same liquid level. Thus, the liquid levels of the liquids 610 in all of the liquid storage tanks 61 are changed and the hanged object 71 pulls the fiber-optic cable 72 downward due to invariant gravity and variant buoyant force. Thus, grating length of the fiber Bragg grating changes, and the reflected signal that is generated when the light signal passes through the fiber-optic cable 72 changes accordingly. By detecting changes in the reflected signal, a monitoring staff can find out that subsidence, slope collapse, or landslide might occur somewhere and is able to provide timely warnings.

However, generally, the conventional subsidence sensing device is placed outdoors, and the outdoor environment is harsh and has large temperature or humidity changes. Especially under the direct sunlight in summer, a lot of liquids 610 in the liquid storage tanks 61 evaporates, causing the liquids 610 in the liquid storage tanks 61 decreasing gradually and the liquid levels of the liquids 610 being lowered down. Once the liquid levels of the liquids 610 are lowered to become lower than the hanged objects 71, false signals would be sent and a wrong result would be received.

To overcome the shortcomings, the present invention provides a subsidence sensing device with a liquid replenishing mechanism to mitigate or obviate the aforementioned problems.

### SUMMARY OF THE INVENTION

The main objective of the present invention is to provide a subsidence sensing device that has multiple liquid storage tanks, multiple level sensors, a liquid feeding tank, an air inlet tube, and a liquid feeding tube. Each of the liquid storage tanks contains liquid and the liquid storage tanks are connected with each other via communicating tubes. The level sensors are mounted on the liquid storage tanks respectively. The liquid feeding tank is disposed higher than liquid surfaces of the liquids in the liquid storage tanks and contains feeding liquid. The air inlet tube has an upper open end protruding into the feeding liquid in the liquid feeding tank and a lower open end protruding into the liquid in a corresponding one of the liquid storage tanks. The liquid feeding tube has an upper open end protruding into the feeding liquid in the liquid feeding tank and a lower open end protrudes into the liquid in a corresponding one of the liquid storage tanks. The feeding liquid in the liquid feeding tank flows into and fills the air inlet tube and the liquid feeding tube and a length that the liquid feeding tube protrudes in the liquid of the corresponding one of the liquid storage tanks is longer than a length that the air inlet tube protrudes in the liquid of the corresponding one of the liquid storage tanks.

When the liquids in the liquid storage tanks evaporate gradually due to surrounding temperature or humidity, the feeding liquid in the liquid feeding tank flows into the liquid storage tank through the liquid feeding tube and replenish all of the liquid storage tanks via the communicating tubes. Thus, the liquid surfaces of the liquids in the liquid storage tanks can be kept at a predetermined proper liquid level, so as to prevent the level sensors from sending false signals.

Other objectives, advantages and novel features of the invention will become more apparent from the following detailed description when taken in conjunction with the accompanying drawings.

### BRIEF DESCRIPTION OF THE DRAWINGS

FIG. 1 is a partial perspective view of a first embodiment of a subsidence sensing device with a liquid replenishing mechanism in accordance with the present invention;

FIG. 2 is a schematic illustration of the subsidence sensing device with the liquid replenishing mechanism in FIG. 1;

FIG. 3 is an operational schematic illustration of the subsidence sensing device with the liquid replenishing mechanism in FIG. 1, showing that one liquid storage tank subsides and liquids in all of the liquid storage tanks have not yet balanced out to the same liquid level;

FIG. 4 is another operational schematic illustration of the subsidence sensing device with the liquid replenishing mechanism in FIG. 1, showing that one liquid storage tank subsides and the liquids in all of the liquid storage tanks balance out to the same liquid level;

FIG. 5 is a schematic illustration of a second embodiment of a subsidence sensing device with a liquid replenishing mechanism in accordance with the present invention;

FIG. 6 is an operational schematic illustration of the subsidence sensing device with the liquid replenishing mechanism in FIG. 5, showing that one liquid storage tank subsides and liquids in all of the liquid storage tanks have not yet balanced out to the same liquid level;

FIG. 7 is another operational schematic illustration of the subsidence sensing device with the liquid replenishing mechanism in FIG. 5, showing that one liquid storage tank subsides and the liquids in all of the liquid storage tanks balance out to the same liquid level;

FIG. 8 is a schematic illustration of a third embodiment of a subsidence sensing device with a liquid replenishing mechanism in accordance with the present invention, showing a level sensor being a magnetostrictive position sensor; and

FIG. 9 is a schematic illustration of a subsidence sensing device in accordance with the prior art.

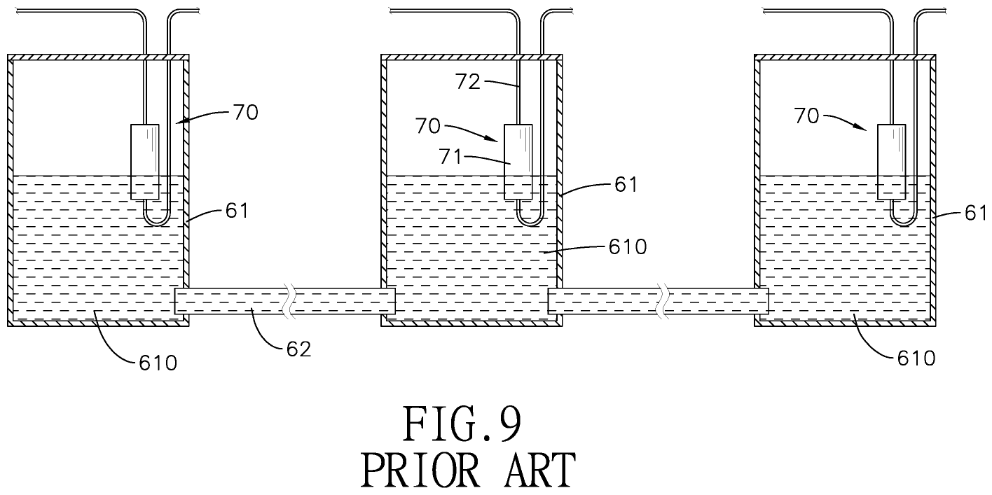

### DETAILED DESCRIPTION OF THE PREFERRED EMBODIMENTS

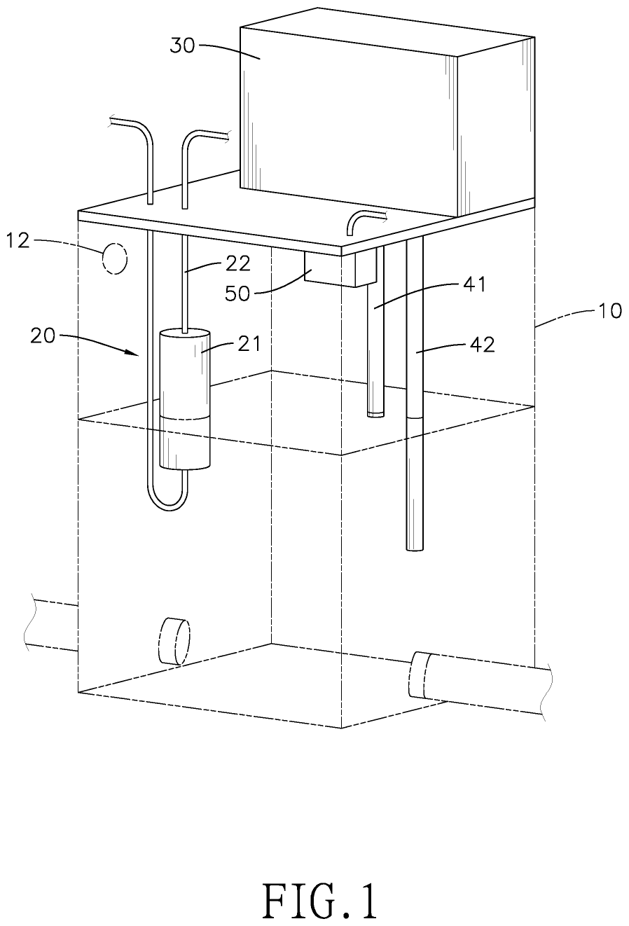

With reference to FIGS. 1, 2 and 8, a subsidence sensing device with a liquid replenishing mechanism comprises multiple liquid storage tanks 10, multiple level sensors 20, 20A, a liquid feeding tank 30, an air inlet tube 41, and a liquid feeding tube 42.

Each of the liquid storage tanks 10 contains liquid 101, and the liquid storage tanks 10 are connected with each other via communicating tubes 11. Thus, according to Communicating Vessel's principle of Hydrostatics, the liquids 101 in all of the liquid storage tanks 10 balance out to the same liquid level. Moreover, each of the liquid storage tanks 10 has an air hole 12 formed through the liquid storage tank 10, such that the liquids 101 in the liquid storage tanks 10 are subjected to the same atmospheric pressure.

The level sensors 20, 20A are mounted on the liquid storage tanks 10 respectively, and are used to detect liquid levels of the liquids 101 in the liquid storage tanks 10.

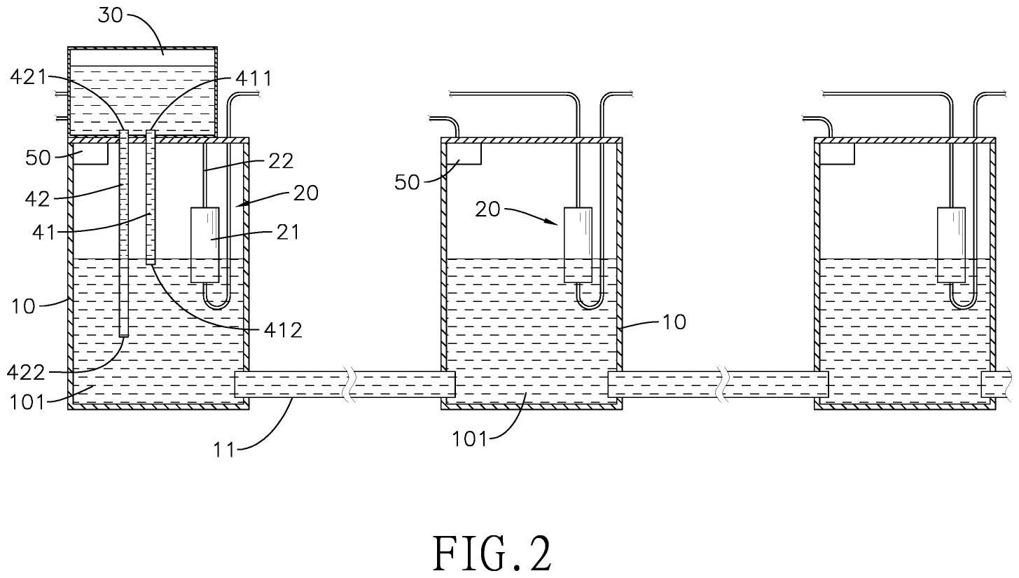

As shown in FIG. 2, in one preferred embodiment of the present invention, each of the level sensors 20 may be a fiber Bragg grating sensor. The fiber Bragg grating sensor has a hanged object 21 and a fiber-optic cable 22. An average density of the hanged object 21 is greater than a density of the liquid 101 in the liquid storage tank 10. The hanged object 21 is disposed at a liquid surface of the liquid 101 in the liquid storage tank 10 and is supported by buoyant force from the liquid 101. The fiber-optic cable 22 is mounted through and is connected with the hanged object 21. A fiber core of the fiber-optic cable 22 is inscribed with fiber Bragg grating. The fiber-optic cable 22 that protrudes out from a top of the hanged object 21 is further securely connected to a top of the liquid storage tank 10 and is wirelessly connected to an optical sensing interrogator.

Moreover, each of the liquid storage tanks 10 may also be equipped with a temperature sensor 50. The temperature sensor 50 is used to detect temperature around the fiber Bragg grating sensor. Since grating lengths of the fiber Bragg grating of the fiber-optic cable 22 is sensitive to temperature and strain, results of changes due to temperature variation in the fiber Bragg grating can be compensated or subtracted by detecting the temperature around the fiber Bragg grating sensor, so as to get an accurate result. The fiber-optic cable 22 with the fiber Bragg grating is a conventional sensor, and therefore, further details of the fiber-optic cable 22 is omitted.

With reference to FIG. 2, the liquid feeding tank 30 is disposed higher than the liquid surfaces of the liquids 101 in the liquid storage tanks 10 and contains feeding liquid 301.

The air inlet tube 41 has an upper open end 411 and a lower open end 412. The upper open end 411 of the air inlet tube 41 protrudes into the feeding liquid 301 in the liquid feeding tank 30. The lower open end 412 of the air inlet tube 41 protrudes into the liquid 101 in a corresponding one of the liquid storage tanks 10. The liquid feeding tube 42 also has an upper open end 421 and a lower open end 422. The upper open end 421 of the liquid feeding tube 42 protrudes into the feeding liquid 301 in the liquid feeding tank 30. The lower open end 422 of the liquid feeding tube 42 protrudes into the liquid 101 in a corresponding one of the liquid storage tanks 10. The feeding liquid 301 in the liquid feeding tank 30 flows into and fills the air inlet tube 41 and the liquid feeding tube 42 and a length that the liquid feeding tube 42 protrudes in the liquid 101 of the corresponding one of the liquid storage tanks 10 is longer than a length that the air inlet tube 41 protrudes in the liquid 101 of the corresponding one of the liquid storage tanks 10.

With the subsidence sensing device as described above, when the liquids 101 in the liquid storage tanks 10 evaporate gradually due to surrounding temperature or humidity until the liquid level of the liquid 101 in the liquid storage tank 10, on which the air inlet tube 41 and the liquid feeding tube 42 are mounted, is lowered to become lower than the lower open end 412 of the air inlet tube 41, the feeding liquid 301 in the liquid feeding tank 30 would flow into the liquid storage tank 10 through the liquid feeding tube 42 and replenish all of the liquid storage tanks 10 via the communicating tubes 11 until the lower open end 412 of the air inlet tube 41 is submerged by the liquid 101. Thus, the liquid surfaces of the liquids 101 in the liquid storage tanks 10 can be kept at a predetermined proper liquid level, so as to prevent the liquid levels from becoming lower than the hanged objects 21 and the level sensors 20, 20A from sending false signals.

As shown in FIGS. 1 and 2, in the first preferred embodiment of the present invention, the liquid feeding tank 30 is mounted on the top of one of the liquid storage tanks 10.

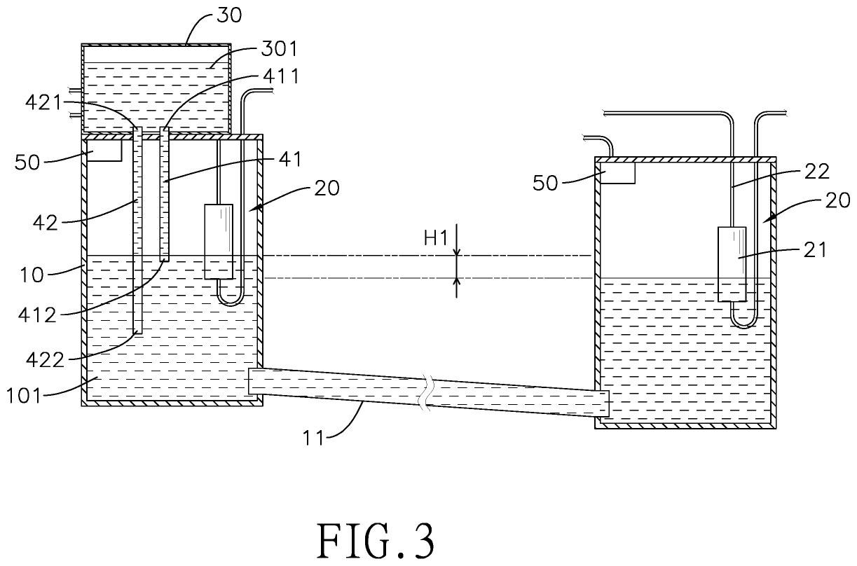

With further reference to FIG. 3, when a place, at which one of the liquid storage tanks 10 is located, subsides and said liquid storage tank 10 is lowered down a first height H1, the liquids 101 in the other liquid storage tanks 10 that are located at places that do not subside flow toward the lowered liquid storage tank 10 until the liquid surfaces of the liquids 101 in all of the liquid storage tanks 10 reach the same liquid level.

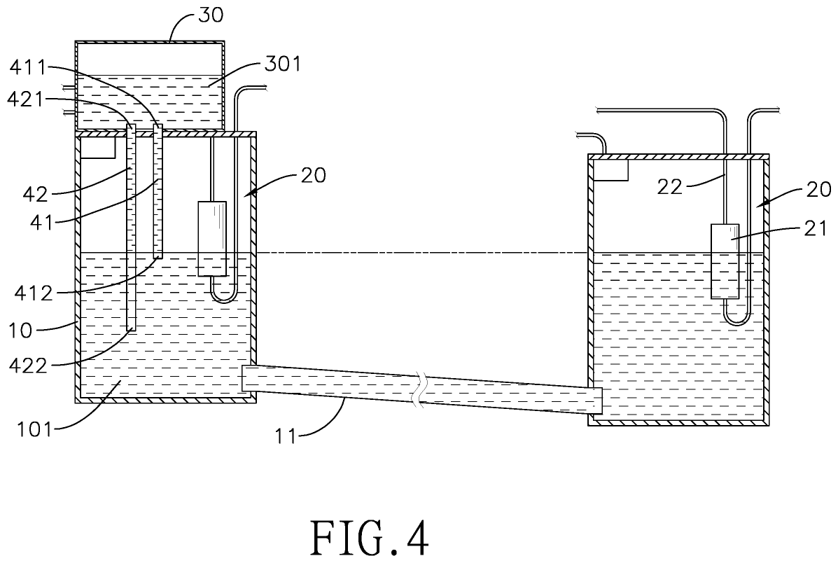

With further reference to FIG. 4, if the liquid levels of the liquids 101 in the liquid storages tanks 10 are lowered to become lower than the lower open end 412 of the air inlet tube 41, the feeding liquid 301 in the liquid feeding tank 30 flows into the liquid storage tank 10 through the liquid feeding tube 42 and replenishes all of the liquid storage tanks 10 via the communicating tubes 11 until the lower open end 412 of the air inlet tube 41 is submerged by the liquid 101. To the liquid storage tank 10 that is located at the subsided place, the liquid 101 inside said liquid storage tank 10 increases and the liquid level rises locally. Thus, the buoyant force applied to the hanged object 21 of the level sensor 20 that is mounted on said liquid storage tank 10 increases and grating length of the fiber Bragg grating of the fiber-optic cable 22 decreases. A reflected signal that is generated when a light signal passes through the fiber-optic cable 22 changes accordingly. By detecting changes in the reflected signals, a monitoring staff can find out that subsidence, slope collapse, or landslide might occur somewhere and is able to provide timely warnings.

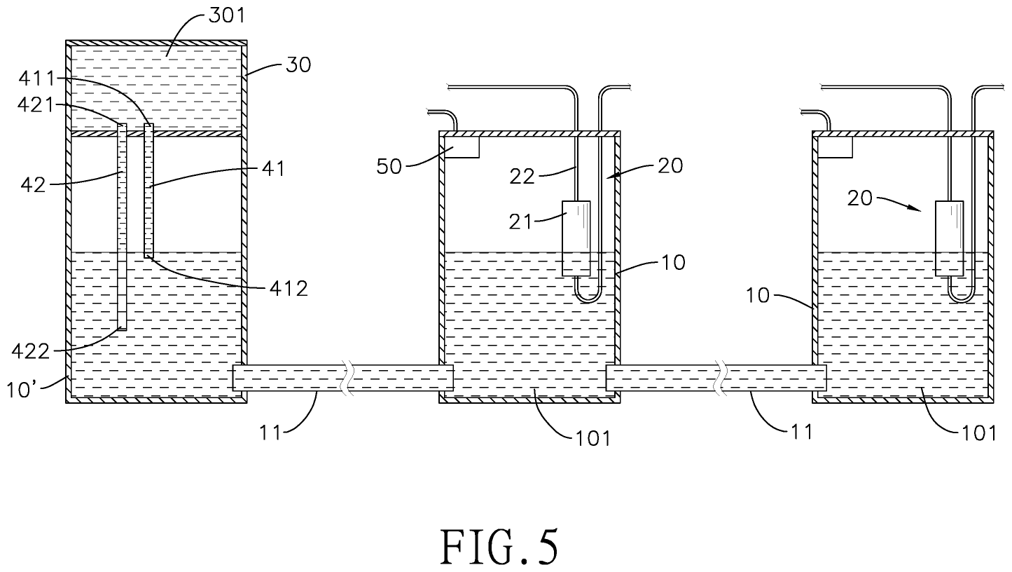

With further reference to FIG. 5, the second preferred embodiment of the present invention is shown. On the liquid storage tank 10′, on which the liquid feeding tank 30 is mounted, the level sensor 20 can be omitted. Thus, the feeding liquid 301 in the liquid feeding tank 30 and the liquid 101 in the liquid storage tank 10′ for mounting the liquid feeding tank 30 can be simply used for replenishing the other liquid storage tanks 10.

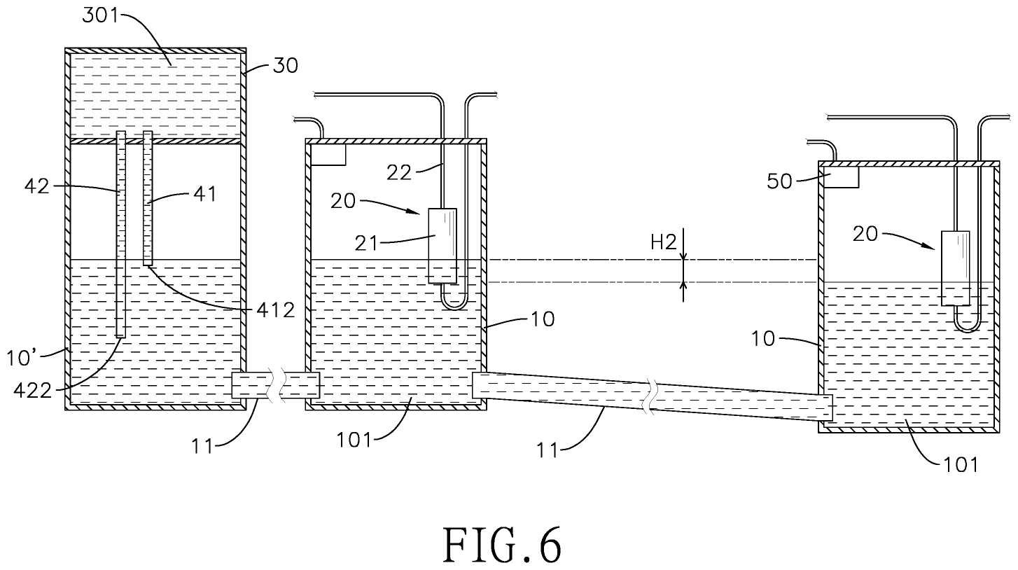

With further reference to FIG. 6, when the place, at which one of the liquid storage tank 10 is located, subsides and said liquid storage tank 10 is lowered down a second height H2, the liquids 101 in the other liquid storage tanks 10, 10′ that are located at places that do not subside flow toward the lowered liquid storage tank 10 until the liquid surfaces of the liquids 101 in all of the liquid storage tanks 10, 10′ reach the same liquid level.

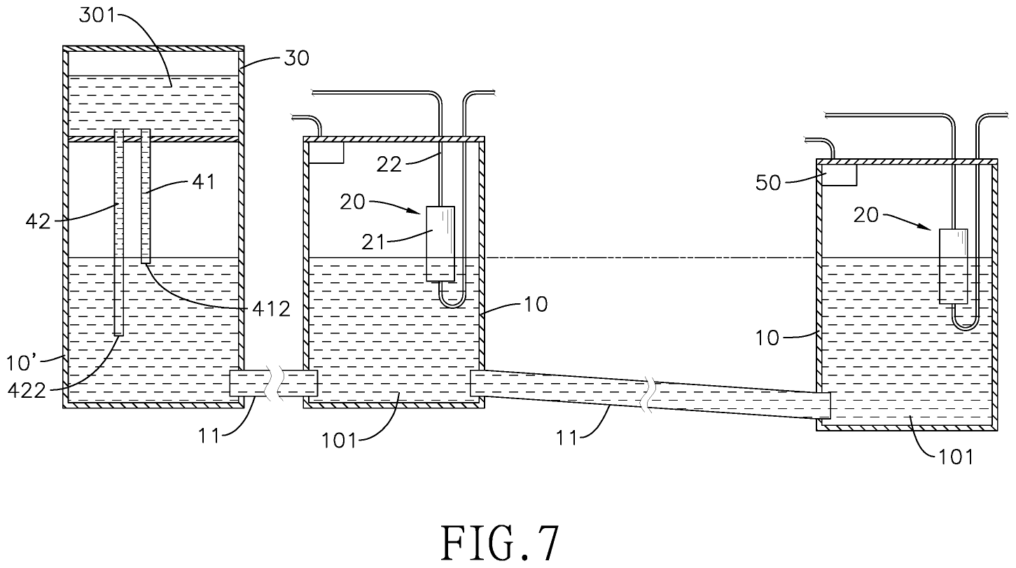

With further reference to FIG. 7, similarly, if the liquid levels of the liquids 101 in the liquid storage tanks 10 are lowered to become lower than the lower open end 412 of the air inlet tube 41, the feeding liquid 301 in the liquid feeding tank 30 flows into the liquid storage tank 10′ below through the liquid feeding tube 42 and replenishes all of the liquid storage tanks 10, 10′ via the communicating tubes 11 until the lower open end 412 of the air inlet tube 41 is submerged by the liquid 101. To the liquid storage tank 10 that is located at the subsided place, the liquid 101 inside said liquid storage tank 10 increases and the liquid level rises locally. Thus, by detecting changes in the reflected signals, a monitoring staff can find out that subsidence, slope collapse, or landslide might occur somewhere and is able to provide timely warnings.

Thus, as shown in FIGS. 3, 4, 6, and 7, in the subsidence sensing device having the liquid feeding tank 30 as described, although the liquid levels of the liquids 101 in the liquid storage tanks 10, 10′ would be adjusted to submerge the lower open end 412 of the air inlet tube 41 when the settlement of other subsidence sensing devices happen, changes in the liquid levels of the liquids 101 of the liquid storage tanks 10 can still be detected by the level sensors 20 respectively.

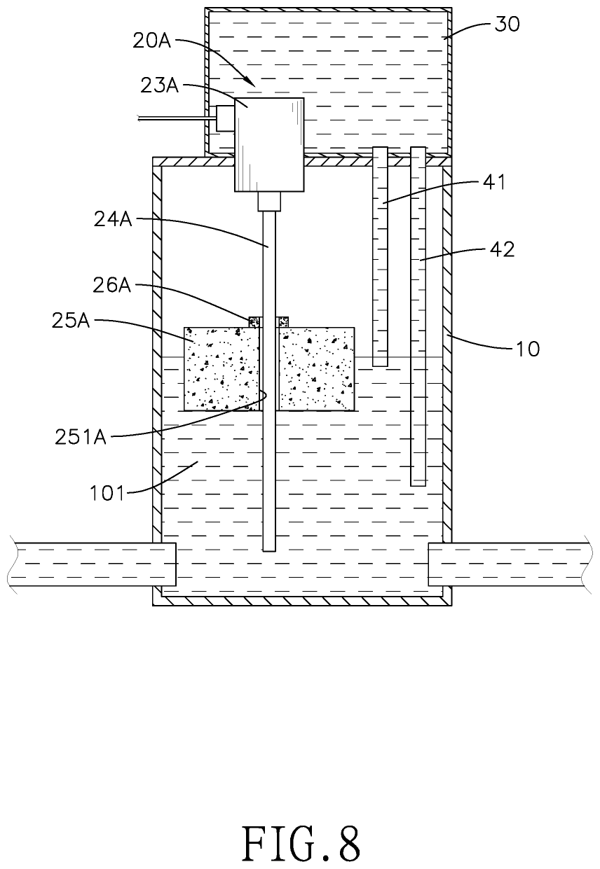

With further reference to FIG. 8, in another preferred embodiment of the present invention, each of the level sensors 20A may be a magnetostrictive position sensor. The magnetostrictive position sensor has a control module 23A, a waveguide 24A, a floating body 25A, and an annular magnet 26A. The control module 23A is mounted on a corresponding one of the liquid storage tanks 10. The waveguide 24A has sensing elements made of magnetostrictive material. An upper end of the waveguide 24A is connected to the control module 23A and a lower portion of the waveguide 24A protrudes into the liquid 101 of the corresponding one of the liquid storage tanks 10, so that the waveguide 24A is longitudinally disposed in the corresponding one of the liquid storage tanks 10. An average density of the floating body 25A is less than the density of the liquid 101 in the corresponding one of the liquid storage tanks 10, such that the floating body 25A can move up and down as the liquid level rises and falls. The floating body 25A has a through hole 251A defined through an upper surface and a bottom surface of the floating body 25A. The annular magnet 26A is securely attached to the floating body 25A and is coaxial with the through hole 251A of the floating body 25A. The waveguide 24A is mounted through the through hole 251A of the floating body 25A and the annular magnet 26A, and the movements of the floating body 25A and the annular magnet 26A are not restricted by the waveguide 24A.

The afore-mentioned control module 23A produces a strain pulse that moves along the waveguide 24A. A magnetic field formed by the strain pulse interacts with a magnetic field of the annular magnet 26A to produce a signal and the signal is transmitted to the control module 23A via the waveguide 24A. Since a transmission time of the signal in the waveguide 24A is proportional to a distance between the annular magnet 26A and the control module 23, the changes in the liquid level of the liquid 101 in the liquid storage tank 10 can be detected.

In addition to the fiber Bragg grating sensor and the magnetostrictive position sensor, the level sensor 20, 20A may also be devices, such as a vibrating wire sensor or a hydrostatic pressure level sensor, that are able to detect the changes in the liquid level of the liquid 101 in the liquid storage tank 10.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A subsidence sensing device comprising:
multiple liquid storage tanks, each of the liquid storage tanks containing liquid, and the liquid storage tanks connected with each other via communicating tubes;
multiple level sensors mounted on the liquid storage tanks respectively;
a liquid feeding tank disposed higher than liquid surfaces of the liquids in the liquid storage tanks and containing feeding liquid;
an air inlet tube having
an upper open end protruding into the feeding liquid in the liquid feeding tank; and
a lower open end protruding into the liquid in a corresponding one of the liquid storage tanks; and
a liquid feeding tube having
an upper open end protruding into the feeding liquid in the liquid feeding tank; and
a lower open end protrudes into the liquid 101 in a corresponding one of the liquid storage tanks;
wherein the feeding liquid in the liquid feeding tank flows into and fills the air inlet tube and the liquid feeding tube and a length that the liquid feeding tube protrudes in the liquid of the corresponding one of the liquid storage tanks is longer than a length that the air inlet tube protrudes in the liquid of the corresponding one of the liquid storage tanks.

2. The subsidence sensing device as claimed in claim 1, wherein the liquid feeding tank is mounted on a top of one of the liquid storage tanks.

3. The subsidence sensing device as claimed in claim 1, wherein
the liquid feeding tank is mounted on a top of one of the liquid storage tanks; and
on the liquid storage tank, on which the liquid feeding tank is mounted, the level sensor is omitted.

4. The subsidence sensing device as claimed in claim 1, wherein each of the level sensors is a fiber Bragg grating sensor.

5. The subsidence sensing device as claimed in claim 2, wherein each of the level sensors is a fiber Bragg grating sensor.

6. The subsidence sensing device as claimed in claim 3, wherein each of the level sensors is a fiber Bragg grating sensor.

7. The subsidence sensing device as claimed in claim 4, wherein each of the fiber Bragg grating sensor has
a hanged object disposed at the liquid surface of the liquid in the liquid storage tank; and
a fiber-optic cable mounted through and connected with the hanged object and the fiber-optic cable that protrudes out from a top of the hanged object securely connected to a top of the liquid storage tank, wherein a fiber core of the fiber-optic cable is inscribed with fiber Bragg grating.

8. The subsidence sensing device as claimed in claim 5, wherein each of the fiber Bragg grating sensor has
a hanged object disposed at the liquid surface of the liquid in the liquid storage tank; and
a fiber-optic cable mounted through and connected with the hanged object and the fiber-optic cable that protrudes out from a top of the hanged object securely connected to the top of the liquid storage tank, wherein a fiber core of the fiber-optic cable is inscribed with fiber Bragg grating.

9. The subsidence sensing device as claimed in claim 6, wherein each of the fiber Bragg grating sensor has
a hanged object disposed at the liquid surface of the liquid in the liquid storage tank; and
a fiber-optic cable mounted through and connected with the hanged object and the fiber-optic cable that protrudes out from a top of the hanged object securely connected to the top of the liquid storage tank, wherein a fiber core of the fiber-optic cable is inscribed with fiber Bragg grating.

10. The subsidence sensing device as claimed in claim 4, wherein each of the liquid storage tanks is equipped with a temperature sensor, and the temperature sensor detects temperature around the fiber Bragg grating sensor.

11. The subsidence sensing device as claimed in claim 5, wherein each of the liquid storage tanks is equipped with a temperature sensor, and the temperature sensor detects temperature around the fiber Bragg grating sensor.

12. The subsidence sensing device as claimed in claim 6, wherein each of the liquid storage tanks is equipped with a temperature sensor, and the temperature sensor detects temperature around the fiber Bragg grating sensor.

13. The subsidence sensing device as claimed in claim 7, wherein each of the liquid storage tanks is equipped with a temperature sensor, and the temperature sensor detects temperature around the fiber Bragg grating sensor.

14. The subsidence sensing device as claimed in claim 8, wherein each of the liquid storage tanks is equipped with a temperature sensor, and the temperature sensor detects temperature around the fiber Bragg grating sensor.

15. The subsidence sensing device as claimed in claim 9, wherein each of the liquid storage tanks is equipped with a temperature sensor, and the temperature sensor detects temperature around the fiber Bragg grating sensor.

16. The subsidence sensing device as claimed in claim 1, wherein each of the level sensors is a magnetostrictive position sensor.

17. The subsidence sensing device as claimed in claim 2, wherein each of the level sensors is a magnetostrictive position sensor.

18. The subsidence sensing device as claimed in claim 3, wherein each of the level sensors is a magnetostrictive position sensor.

19. The subsidence sensing device as claimed in claim 1, wherein each of the liquid storage tanks has an air hole formed through the liquid storage tank.
